(19) United States
(12) Patent Application Publication
(10) Pub. No.: US 2011/0292644 A1
(43) Pub. Date: Dec. 1, 2011

(54) APPARATUS AND METHOD FOR CONVERTING GAZING GLOBES AND OTHER DECORATIVE OBJECTS INTO GLOW-IN-THE-DARK PRODUCTS

(76) Inventor: Richard Cohen, Ann Arbor, MI (US)

(21) Appl. No.: 13/117,464

(22) Filed: May 27, 2011

Related U.S. Application Data
(63) Continuation-in-part of application No. 12/820,427, filed on Jun. 22, 2010.
Application No. 12/820,427 is a continuation-in-part of application No. 11/472,716, filed on Jun. 22, 2006, now Pat. No. 7,784,956.
(60) Provisional application No. 60/693,361, filed on Jun. 23, 2005.

(51) Int. Cl. F21L 4/08

(52) U.S. Cl. 362/183

(57) ABSTRACT

A light source causes hollow objects to glow in the dark (GID), thereby extending the operating period of light-activated materials in gazing globes and other decorative or ornamental objects. The light source may be provided as part of a conversion kit, enabling objects from different manufacturers to be converted to GID objects following purchase. A base unit includes the light emitter supported to illuminate the object from the inside out. The base unit further includes at least one solar panel facing into the interior of the object, and one or more batteries charged by the solar panel to power the light emitter. A device is used to couple the base unit to the rim of the object. In the preferred embodiment, the device for coupling the base unit to the rim of the object is an elastomeric ring that stretches over the rim of the object, thereby forming a seal.

### REFERENCE TO RELATED APPLICATIONS

This application is a continuation-in-part of U.S. patent application Ser. No. 12/820,427, filed Jun. 22, 2010, which is a continuation-in-part of U.S. patent application Ser. No. 11/472,716, filed Jun. 22, 2006, which claims priority to U.S. Provisional Patent Application Ser. No. 60/693,361, filed Jun. 23, 2005, the entire content of each application being incorporated herein by reference.

### FIELD OF THE INVENTION

This invention relates generally to decorative objects and, in particular, gazing globes and other ornamental objects including light sources and light-activated materials.

### BACKGROUND OF THE INVENTION

U.S. Pat. No. 7,252,889 describes a method of fabricating glow-in-the-dark gazing globes or other objects, as well as the articles that result. The method comprises the steps of providing a hollow form having an inner wall made from a transparent or translucent material, the form including an aperture for gaining access to the interior thereof, and introducing one more photoluminescent pigments into the form through the aperture so that they cling to the inner wall. In alternative embodiments, the pigments may be applied without an adhesive, as by naturally cling, vacuum evaporation, or other techniques. If the object is a gazing globe, a supporting stand may be included. A plurality of different pigments may be introduced into the form to create a decorative or swirling effect. One drawback with the approach just described is that after a few hours following sundown, the light-emitting capabilities of these materials falls off, resulting in a product which no longer glows as nighttime continues.

Co-pending U.S. utility patent application Ser. No. 12/820,427, the entire content of which is incorporated herein by reference, improves upon the existing art by providing a light source to extend the operating period of light-activated materials in gazing globes and other decorative or ornamental objects. A solar cell is used to charge a battery during the day, allowing for a completely self-contained system. A photocell may be provided to turn the light source on and off, thereby limiting illumination to dark periods, conserving battery power. In one previously disclosed embodiment, the control electronics are contained in a base unit upon which the solar cell is mounted. The lower rim of the object to be illuminated press fits into the base unit using an elastomeric ring providing a leak-free fit. This also allows the object to be pulled out of the base unit for maintenance, if necessary. With such a configuration, the solar cell is disposed within the object to be illuminated, and the batteries are recharged as solar energy shines through the object during daylight hours.

### SUMMARY OF THE INVENTION

This invention improves upon the existing art by providing a light source causing hollow objects to glow in the dark (GID), thereby extending the operating period of light-activated materials in gazing globes and other decorative or ornamental objects. The invention may be provided as a conversion kit, enabling objects from different manufacturers to be converted to GID objects following purchase.

Apparatus according to the invention for causing a hollow object to glow in the dark, the object having an interior with an opening having a rim, comprises a base unit including a light emitter supported to illuminate the object from the inside out. The base unit further includes at least one solar panel facing into the interior of the object, and one or more batteries charged by the solar panel to power the light emitter. A device is used to couple the base unit to the rim of the object.

In the preferred embodiment, the device for coupling the base unit to the rim of the object is an elastomeric ring that stretches over the rim of the object, thereby forming a seal. The solar panel may have a bottom edge coupling the solar panel to the base unit at an angle between 0 and 90 degrees. The solar panel may have a top edge to which the light emitter is attached. The light emitter may be a light-emitting diode (LED), including a violet or ultraviolet LED. The apparatus may further including a light detector operative to switch power to the light emitter when a sufficient level of darkness is detected.

### BRIEF DESCRIPTION OF THE DRAWING

FIG. 1 is a drawing which shows the invention applied to a gazing globe;

FIG. 2 is a drawing which shows how the solar panel and battery may be integrated into a stand;

FIG. 3 is a drawing which shows how power may be supplied from a more distant source;

FIG. 4A is a side-view drawing that shows a self-contained embodiment of the invention comprising a teardrop-shaped, glow-in-the-dark (GID) object;

FIG. 4B is a top-view drawing that shows a self-contained embodiment of the invention comprising the teardrop-shaped object;

FIG. 5 is a partially exploded view of the article of FIGS. 4A, 4B;

FIG. 6 is a fully exploded view;

FIG. 7 is a series of cross sections of the teardrop shaped GID object;

FIG. 8A is an oblique drawing of an embodiment of the invention using an alternative elastomeric ring to accommodate different objects to be illuminated;

FIG. 8B is an oblique bottom view of the embodiment of FIG. 8A; and

FIG. 8C depicts an assembly process using the embodiment of FIGS. 8A, 8B.

### DETAILED DESCRIPTION OF THE INVENTION

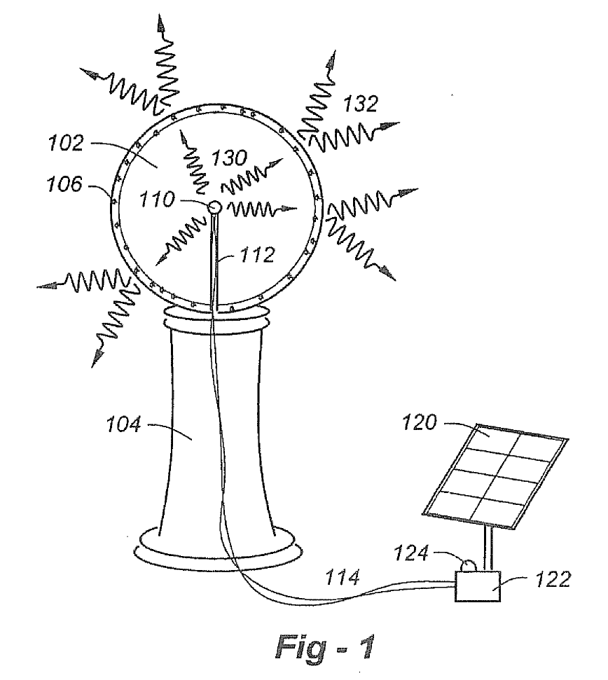

FIG. 1 is a drawing which shows the invention applied to a gazing globe with the understanding that the principles and methods described herein are equally applicable to other indoor/outdoor decorative fixtures, which will be apparent to those of skill in the art.

The device includes a globe 102 which may be solid or hollow, including particles 106 which receive light 130 from one or more sources 110, and emit light 132 after the light source has been removed. Such glow-in-the-dark substances may be photoluminescent, phosphorescent, fluorescent, etc. These substances may either be embedded with the sphere 102, or applied to the interior or exterior surfaces thereof, by whatever appropriate means are available. In the event that the globe 102 or other ornamental object is glass, the particles 106 may be included into the melt prior to solidification, or adhered to the inside of the globe (or outside of the globe) through appropriate adhesives. Suitable plastics, including polycarbonates, may be used as an alternative to glass. The globe 102 or other object is preferably supported on a stand 104. The light-activated materials may be applied to create a ‘swirling effect’ when activated

The light source 110 is used to provide wavelengths to activate the particles 106, typically after sunset. While the light source 110 may be used externally to the globe 102, in the preferred embodiment, it is held upright by a post 112 central to the inside of a hollow object, allowing for a relatively uniform illumination of the particles 106 while, at the same time, providing for a relatively discrete placement of the source 110. Although different wavelengths may he used, emitter 110 is preferably a violet or ultraviolet light-emitting diode (LED), which are now commercially available with quite high brightness levels. Utilizing common photo-active materials, light in this wavelength range causes the particles 106 to glow quite brightly, and assuming sufficient illumination during the day, this may achieve a glow-in-the-dark effect all night long in some cases. Although a single emitter 110 is shown, clearly multiple emitters may be used, including emitters closer to the particles 106

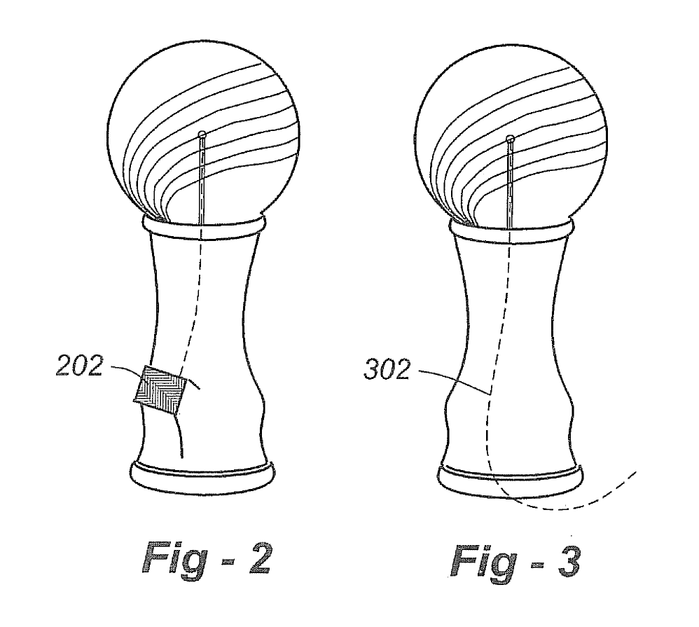

In the preferred embodiment, the source 110 is powered by an integrated module 202 built into the stand, as shown in FIG. 2. The module contains the solar panel, battery and necessary electronics. Preferably, a light sensor is used switching power from the batteries to the source 110 after a sufficient level of darkness has been achieved. This photocell may be located anywhere on the stand. In an alternative embodiment, a module 122 may provide power wires 114, allowing solar panel 120 to be located remotely from the ornamental object. In this case, a light sensor 124 may be mounted on the module. As a further alternative, power may be supplied from a more remote source through wires 302 shown in FIG. 3, allowing for ON/OFF operation from a house, for example, without the need for a solar panel.

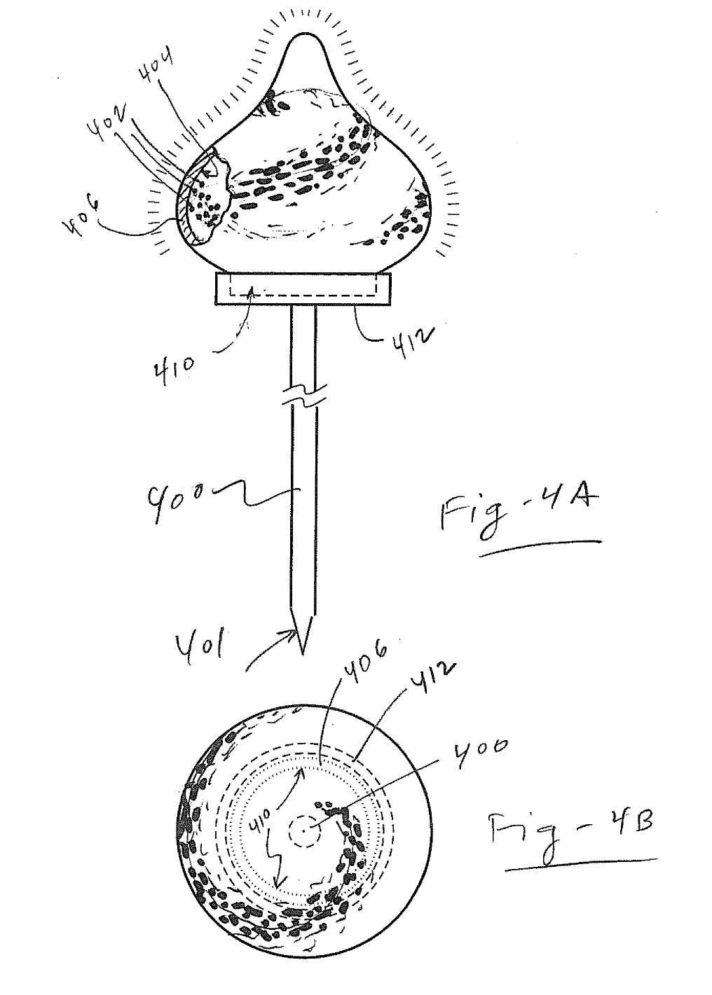

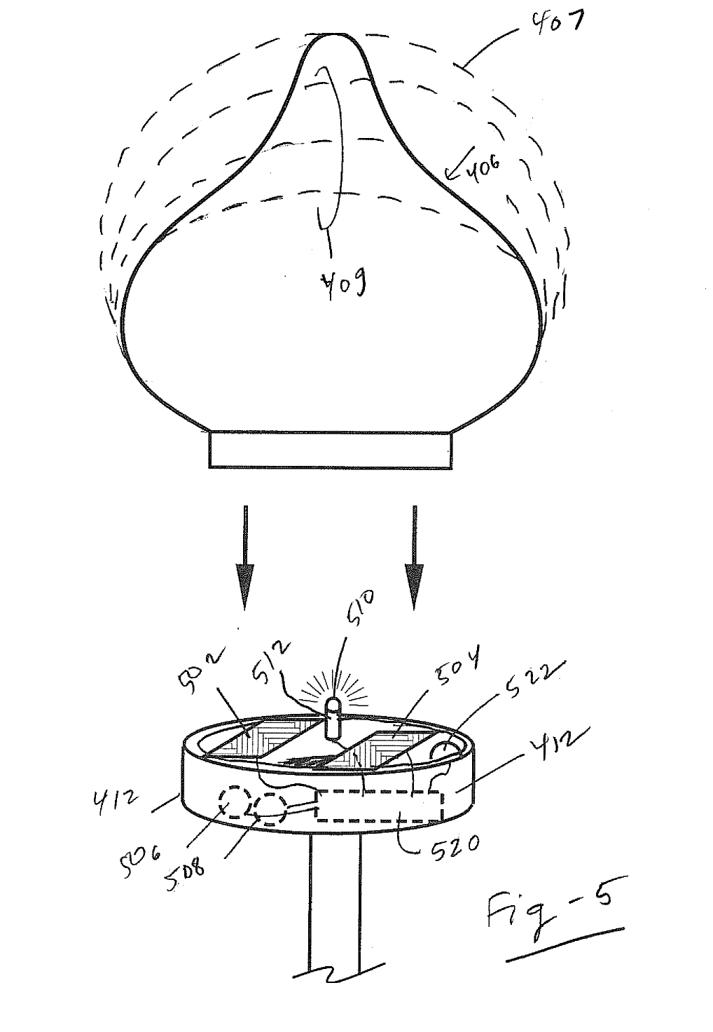

FIG. 4A is a side-view drawing that shows a self-contained embodiment of the invention comprising a teardrop-shaped, glow-in-the-dark (GID) object situated on an stake 400 with may include an earth-piercing point 401. FIG. 4B is a top-down view. “Self-contained” is this case means that the solar panel is located with its collection surface facing into the hollow interior of the object, as explained in further detail below.

In the embodiment of FIG. 4A, the GID particles 402 are adhered to the inner wall 404 of the hollow object 406 to create a pattern that spirals or swirls around the object from at least near the top to at least near the bottom. Differently shaped objects such a spheres 407 409 and ‘flattened’ spheres depicted with broken lines in FIG. 5. To create this GID pattern, glue is applied is the spiral pattern to the inner wall 404 with a long brush through the bottom opening of the form at 410 prior to installation on base 412. While the adhesive is still tacky, the object is filled with the GID particles and shaken in some cases so that they cling to the inner wall and become affixed thereto. The excess particles may be reclaimed for subsequent use.

FIG. 5 is a partially exploded view of the article of FIGS. 4A, 4B. As can be seen, base 412 includes one or more solar panels 502, 504 used to recharge one or more batteries 506, 508 to power LED 510. In the preferred embodiment, LED is a violet or ultraviolet LED to enhance the activation of the GID particles. The LED may be supported on a post 412 to bring the emitted closed to the center of the object. The various components are interconnected to control electronics 520, which may further be interconnected to optional photocell 522. A switch (not shown) may also be provided to turn the device ON and OFF.

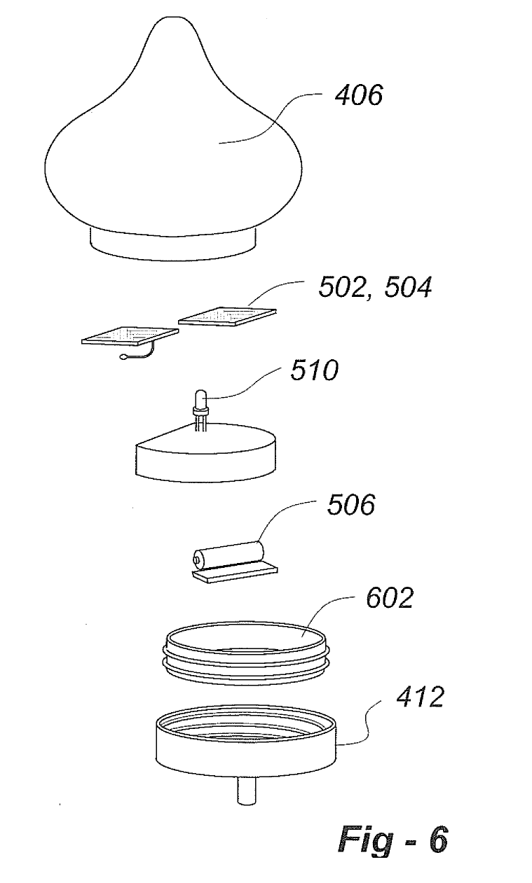

FIG. 6 is a fully exploded view perhaps better illustrating the various component parts. While different assembly techniques may be used, the lower rim of the object 406 press fits into the base 412 using an elastomeric ring 602 providing a leak-free fit. This also allows the object 406 to be pulled out of the base maintenance, if necessary.

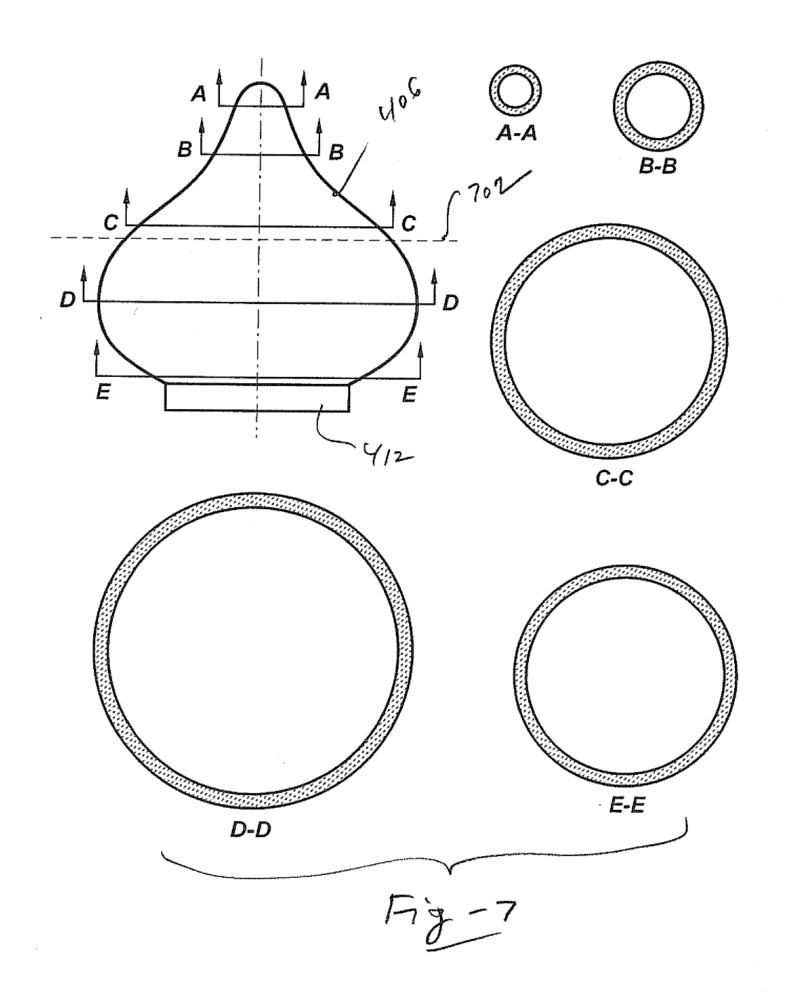

FIG. 7 is a series of cross sections of a teardrop-shaped GID object 406 made in accordance with the invention. Cross sections A-A through E-E, all generally circular, are taken at different horizontal slices through object 405. The horizontal centerline is generally shown at 702. Above this line, cross sections gradually progress from C-C to B-B to A-A in monotonically decreasing sizes. Below the line 702, however, the diameter first assumes a maximum diameter at D-D before reducing at E-E before transitioning into base, thereby resulting in a teardrop or “Hershey's kiss” type configuration.

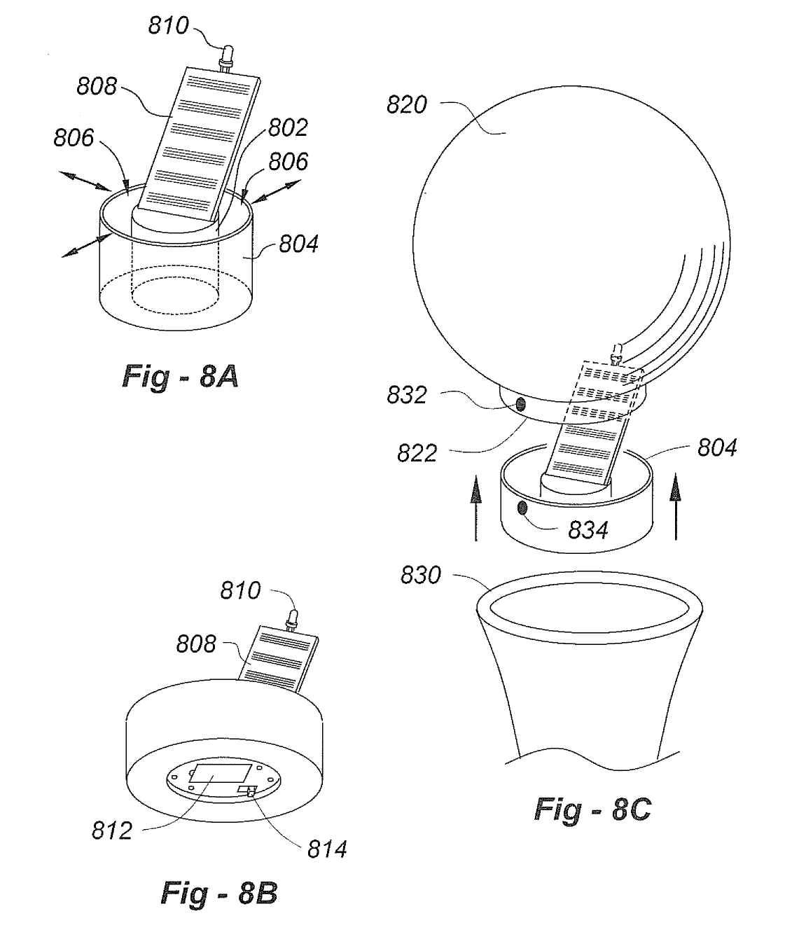

FIG. 8A is an oblique drawing of an embodiment of the invention using an alternative elastomeric ring to accommodate different objects to be illuminated. FIG. 8B is an oblique bottom view of the embodiment of FIG. 8A, and FIG. 8C depicts an assembly process using the embodiment of FIGS. 8A, 8B. The control electronics are housed in a hard plastic base unit 802. An elastomeric ring 804 is coupled to the base unit 802 to create a circular space 806 to receive the rim of an object to be illuminated, such as globe 820 in FIG. 8C.

The elastomeric ring 804 may be stretched to establish a seal against the rims of different plastic or glass objects, including gazing globes of any shape, with or without glow-in-the dark particles. Since such objects may be hand made or hand-blown, the rim diameters may be irregular. The invention may also be provided with different diameter elastomeric rings to accommodate objects of different sizes. For example, the elastomeric ring 804 may have a diameter of approximately 2 inches with the ability to stretch to larger diameters to create a tight seal. Alternatively, the ring 804 may have a diameter of less than 2 inches, or about 2.5, 3, 3.5, 4, 4.5, 5 inches, or larger.

The solar cell 808 may be supported on an angled panel as shown, with one or more LEDs 810 connected to the top edge. The panel may be cemented in position or may be hinged to adjust for light-gathering capability. As with all embodiments disclosed herein, the control electronics may be interconnected to a photocell so that the LEDs) turn ON at dusk (and/or OFF at dawn). As an alternative to a separate photocell, the solar panel itself may also be used as a photodetector for such purposes.

The oblique bottom view of FIG. 8B shows the battery compartment 812 and on-off switch 814. FIG. 8C depicts a typical assembly process. After turning on the switch 814, the elastomeric ring is pulled over the rim 822 of the object 820. The object and illuminator may then be placed in or on a surface or stand of the user's choosing. For example, in the case of a gazing globe, the completed assembly may be positioned onto a stand 830 for interior or outdoor/garden use. The object and/or base unit may be provided with permanent or stick-on markers 832, 834 indicating the best orientation to maximize southern solar exposure.

I claim:

1. Apparatus for causing a hollow object to glow in the dark, the object having an interior with an opening having a rim, the apparatus comprising:
a base unit including a light emitter supported to illuminate the object from the inside out;
the base unit further including at least one solar panel facing into the interior of the object, and one or more batteries charged by the solar panel to power the light emitter; and
a device for coupling the base unit to the rim of the object.

2. The apparatus of claim 1, wherein the device for coupling the base unit to the rim of the object is an elastomeric ring that stretches over the rim of the object forming a seal.

3. The apparatus of claim 1, wherein the solar panel has a bottom edge coupling the solar panel to the base unit at an angle between 0 and 90 degrees.

4. The apparatus of claim 1, wherein:
the solar panel has a bottom edge coupling the solar panel to the base unit at an angle between 0 and 90 degrees; and
a top edge to which the light emitter is attached.

5. The decorative article of claim 1, wherein the light emitter is a light-emitting diode (LED).

6. The apparatus of claim 1, wherein the light emitter is a violet or ultraviolet light-emitting diode (LED).

7. The apparatus of claim 1, further including a light detector operative to switch power to the light emitter when a sufficient level of darkness is detected.
